(19) United States
(12) Patent Application Publication
(10) Pub. No.: US 2022/0309902 A1
(43) Pub. Date: Sep. 29, 2022

(54) INTERACTIVE REMINDING METHOD AND APPARATUS, STORAGE MEDIUM, AND ELECTRONIC DEVICE

(71) Applicant: HuiZhou TCL Mobile Communication Co., Ltd., HuiZhou, Guangdong (CN)

(72) Inventor: Junlan LIN, Huizhou, Guangdong (CN)

(73) Assignee: HuiZhou TCL Mobile Communication Co., Ltd., HuiZhou, Guangdong (CN)

(21) Appl. No.: 17/615,851

(22) PCT Filed: Dec. 30, 2019
(86) PCT No.: PCT/CN2019/129723

§ 371 Date: Dec. 2, 2021

(30) Foreign Application Priority Data
Dec. 19, 2019 (CN) 201911316289.7

(51) Int. Cl. G08B 21/24; H04B 1/3827

(52) U.S. Cl. CPC G08B 21/24; H04B 1/385

(57) ABSTRACT

An interactive reminding method and apparatus, a storage medium, and an electronic device, the interactive reminding method being applied to an electronic device and comprising: in response to a reminder event, applying a voltage onto an electrode sheet for the electrode sheet to transmit the voltage to a user so as to carry out reminding (S701); and in response to receiving feedback of the reminder, stopping applying the voltage on the electrode sheet (S702).

This application claims the benefit of priority of a China Patent Application No. 201911316289.7 submitted to State Intellectual Property Office of the P.R.C. on Dec. 19, 2019, entitled “interactive reminding method, device, storage medium and electronic device”, the contents of which are incorporated herein by reference in their entirety.

### TECHNICAL FIELD

The present invention relates to computer technologies, and more particularly to an interactive reminding method, device, storage medium and electronic device.

### DESCRIPTION OF RELATED ARTS

With development of electronic devices, more and more wearable devices have developed, such as smart watches, smart bands, smart rings, earphones, and smart glasses, gloves, hats, etc. Currently, the approach to reminding a user mainly includes screen flashing reminders, sound reminders and vibration reminders. The vibration reminders are usually realized by a motor. However, in some small wearable devices such as earphones, and products designed to be mounted at locations of eyes and hat brim, the motor cannot be used due to limited space of a product.

However, the screen flashing reminders and the sound reminders may be ignored by users, failing to achieve the purpose of reminding. Further, the strength of message reminders in existing techniques is fixed, and this results in poor user experience.

### SUMMARY

### Technical Problems

The present invention provides an interactive reminding method, device, storage medium and electronic device, for achieving the purpose of reminding a user by stimulating the skin of the user based on an electrode sheet.

### Technical Solutions

In a first aspect, the present invention provides an interactive reminding method, applied to an electronic device, the method including:

in response to a reminder event, applying a voltage to an electrode sheet for the electrode sheet to transmit the voltage to a user for reminding the user; and

in response to receiving a feedback of the reminder, stopping applying the voltage to the electrode sheet.

Preferably, the interactive reminding method further includes altering the voltage applied to the electrode sheet based on an adjusted configuration of the applied voltage made by the user.

Preferably, the voltage on the electrode sheet is a pulse voltage; and wherein the altering the voltage applied to the electrode sheet includes altering at least one of pulse amplitude, pulse period, pulse width and duty ratio of the pulse voltage.

Preferably, the interactive reminding method further including presetting the voltage applied to the electrode sheet based on importance of the reminder event.

Preferably, the importance of the reminder event is determined based on an importance setting made by the user.

Preferably, the applied voltage is treated as voltages applied to the electrode sheet for many times at interval.

Preferably, the applied voltage is a direct-current voltage.

In a second aspect, the present invention provides an interactive reminding device, including:

an electrode sheet, configured to contact with a user;

a control module, configured to apply, in response to a reminder event, a voltage to the electrode sheet for the electrode sheet to transmit the voltage to a user for reminding the user, and configured to stop applying the voltage to the electrode sheet in response to receiving a feedback of the reminder; and

a feedback receiving unit, configured to receive the feedback and notify the control module.

Preferably, the interactive reminding device further includes a voltage adjusting configuration unit, configured to make the control module alter the voltage applied to the electrode sheet based on an adjusted configuration of the applied voltage made by the user.

In a third aspect, the present invention further provides a computer readable storage medium, storing a plurality of program instructions applicable to be loaded by a processor to execute any of the afore-mentioned interactive reminding methods.

In a fourth aspect, the present invention further provides an electronic device, including a processor and a storage that are electrically connected to each other, the storage configured to store program instructions and data, the processor configured to execute any of the afore-mentioned interactive reminding methods.

### Beneficial Effects

The present invention provides an interactive reminding method, device, storage medium and electronic device. In a situation that the electrode sheet of the electronic device contacts with the user, the electronic device applies a voltage to the electrode sheet in response to the reminder event, and the electrode sheet transmits the voltage to the user. The electronic device stops applying the voltage to the electrode sheet in response to a feedback make by the user for the voltage. The electronic device provides the user a message reminder by stimulating the skin of the user by conducting the electrode sheet with electricity. This approach is simple, safe, new and the way of reminding is not easy to be ignored.

### BRIEF DESCRIPTION OF THE DRAWINGS

FIG. 1 is a schematic diagram illustrating an application scenario of an interactive reminding electronic device provided in an embodiment of the present invention.

FIG. 2 is a structural schematic diagram illustrating an electronic device provided in an embodiment of the present invention.

FIG. 3 is another structural schematic diagram illustrating an electronic device provided in an embodiment of the present invention.

FIG. 4 is a structural schematic diagram illustrating an interactive reminding device provided in an embodiment of the present invention.

FIG. 5 is a schematic diagram illustrating an operational interface for a user to achieve voltage setting.

FIG. 6 is a schematic diagram illustrating a waveform of a pulse voltage provided in an embodiment of the present invention.

FIG. 7 is a flowchart of an interactive reminding method provided in an embodiment of the present invention.

### DETAILED DESCRIPTION

The technical solutions in the embodiments of the present invention will be clearly and completely described below with reference to accompanying drawings of the embodiments of the present invention. Obviously, the described embodiments are merely a part of embodiments of the present invention and are not all of the embodiments. Based on the embodiments of the present invention, other embodiments obtained by those of ordinary skill in the art without making any inventive effort are within the scope the present invention seeks to be protected.

An embodiment of the present invention provides an interactive reminding electronic device. The electronic device may be a smart watch, a smart band, a smart ring, an earphone, and a smart glasses, gloves, hat, and the like.

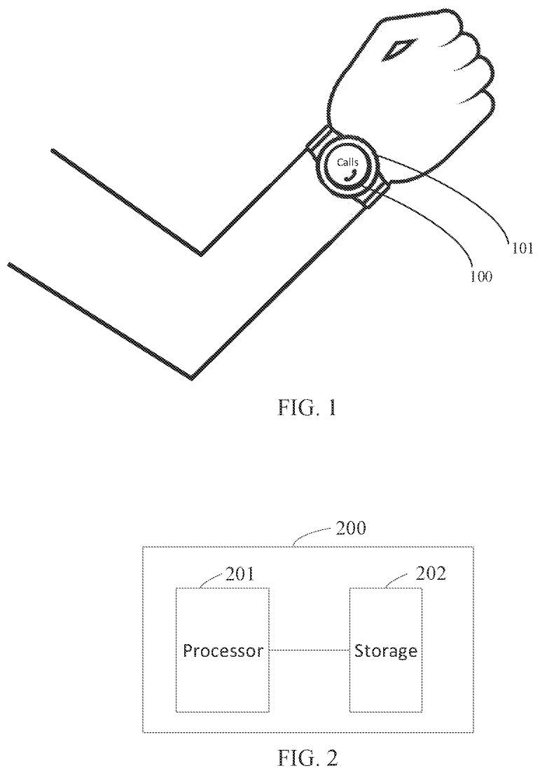

FIG. 1 is a schematic diagram illustrating an application scenario of an interactive reminding electronic device provided in an embodiment of the present invention. The electronic device 100 may be a smart watch, which is provided with an electrode sheet 101 at a rear side of the smart watch. The electrode sheet 101 contacts with a hand of a user. When the electronic device 100 rings or receives a call, a voltage on the electrode sheet 101 will stimulate the skin on the user's hand for reminding the user there is a reminder event. If the user rises his arm at this moment, the electronic device 100 may stop the reminding in response to a feedback of the user. The electronic device 100 may also cancel the reminder of the call.

In the present embodiment, the interactive reminding electronic device 100 provides an event reminder for the user by stimulus made by electricity of the electrode sheet. This approach is simple, safe and it is not easy to be ignored by the user.

FIG. 2 is a structural schematic diagram illustrating an electronic device provided in an embodiment of the present invention. The electronic device 200 includes a processor 201 and a storage 202. The processor 201 and the storage 202 are electrically connected to each other. The processor 201 functions as a control center of the electronic device 200 and is configured to connect each component of the electronic device using various interfaces and circuits, and is configured to execute or load application programs stored in the storage 202, to call the data stored in the storage 202 and to execute various functions of the electronic device and perform data processing, thereby monitoring the overall electronic device.

In the present embodiment, the processor 201 of the electronic device 200 will load the program instructions corresponding to one or more than one functional modules into the storage 202 based on the steps of the interactive reminding method, and the processor 201 will execute the functional modules stored in the storage 202 to realize various functions by executing the following the steps:

in response to a reminder event, applying a voltage to an electrode sheet for the electrode sheet to transmit the voltage to a user for reminding the user; and

in response to receiving a feedback of the reminder, stopping applying the voltage to the electrode sheet.

Preferably, the interactive reminding method further includes altering the voltage applied to the electrode sheet based on an adjusted configuration of the applied voltage made by the user.

Preferably, the voltage on the electrode sheet is a pulse voltage; and

the altering the voltage applied to the electrode sheet includes altering at least one of pulse amplitude, pulse period, pulse width and duty ratio of the pulse voltage.

Preferably, the interactive reminding method further including presetting the voltage applied to the electrode sheet based on importance of the reminder event.

Preferably, the importance of the reminder event is determined based on an importance setting made by the user.

Preferably, the applied voltage is treated as voltages applied to the electrode sheet for many times at interval.

Preferably, the applied voltage may be a direct-current voltage.

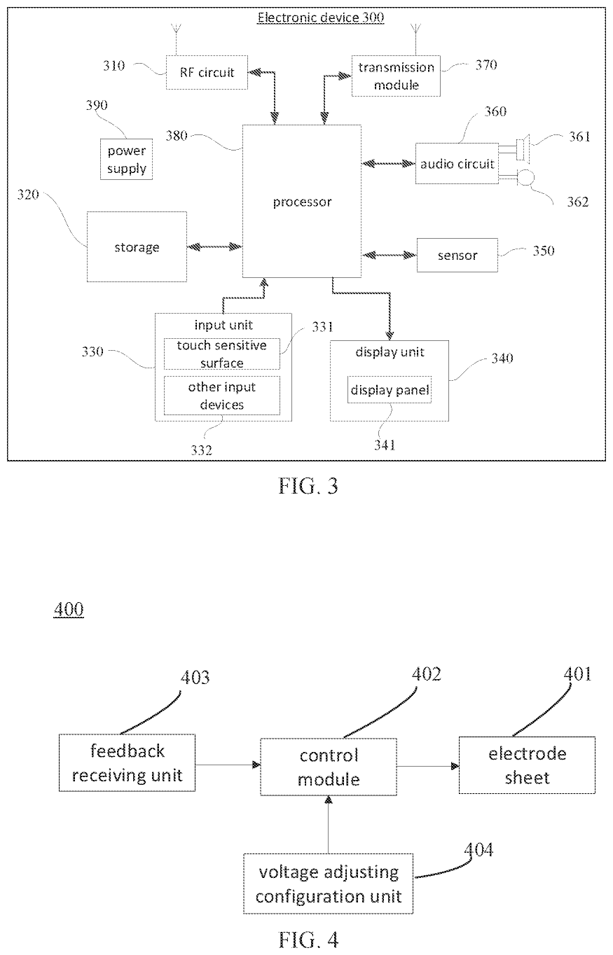

FIG. 3 is another structural schematic diagram illustrating an electronic device provided in an embodiment of the present invention. The electronic device 300 may be a smart watch, a smart band, a smart ring, an earphone, and a smart glasses, gloves, hat, and the like.

The RF circuit 310 is configured to receive and transmit electromagnetic waves to implement conversion between the electromagnetic waves and electrical signals, thereby communicating with a communication network or any other device. The RF circuit 310 may include various existing circuit components for executing the functions, for example, an antenna, an RF transceiver, a digital signal processor, an encryption/decryption chip, a subscriber identity module (SIM) card, a storage, and so on. The RF circuit 310 can communicate with various networks, such as internet, an intranet, or a wireless network, or can communicate with other devices via the wireless network. The above-mentioned wireless network may include a cellular network or a wireless local area network or metropolitan area network. The above-mentioned wireless network may use any one of communication standards, protocols, or technologies, including but not limited to Global System for Mobile communications (GSMC), Enhanced Data GSM Environment (EDGE), Wideband Code Division Multiple Access (WCDMA), Code Division Multiple Access (CDMA), Time Division Multiple Access (TDMA), WWI (such as standards of the Institute of Electrical and Electronics Engineers including IEEE802.11a, IEEE802.11b, IEEE 802.11g, and/or IEEE 802.11n), Voice over Internet Protocol (VoIP), Worldwide Interoperability for Microwave Access (Wi-Max), any other protocol for mails, instant communication, and short messages, any other suitable communication protocol, or any other protocol which has not been developed.

The storage 320 may be used to store application programs and data. The application programs stored in the storage 320 include executable codes. The application programs may construct various functional modules. By executing the application programs stored in the storage 320, the processor 380 may perform various functions and data processing. The storage 320 may include a code area and a data area, in which the code area is for storing an operating system, at least one application program needed for at least a function (such as an audio playback function and an image playback function), and the data area is for storing data (such as audio data and contacts) created according to a use of the electronic device. In addition, the storage 320 may include high-speed random access memory, and may further include non-volatile memory such as one or more magnetic disk storage devices, flash memory, or other non-volatile solid state storages. Correspondingly, the storage 320 may further include a storage controller for controlling access to the storage 320 from the processor 380 and the input unit 330.

The input unit 330 can be configured to receive input numbers or character information, and generate signal input of a keyboard, a mouse, a joystick, or an optical trackball in relation to user settings and functional control. Specifically, the input unit 330 may include a touch sensitive surface 331 and any other input device 332. The touch sensitive surface 331, which is also called a touch screen or a touchpad, can gather a touch operation (for example, operations by use of a finger of a user, a stylus, and any other suitable object or attachment on or near the sensitive surface 331) applied on or near to the touch sensitive surface 331 by the user and drive a connected device according to preset programs. Optionally, the touch sensitive surface 331 may include a touch-sensitive device and a touch controller. The touch-sensitive device detects a direction of the user's touch, detects signals resulted from the touch operation, and transmits the signals to the touch controller. The touch controller receives information of the touch from the touch-sensitive device, converts it into a touch coordinate, further transmits the coordinate to the processor 380, and further receives and executes an instruction from the processor 380. Furthermore, the touch sensitive surface 331 may be implemented by utilizing capacitive, resistive, infrared, and surface acoustic wave technologies. In addition to the touch sensitive surface 331, the input unit 330 may further include any other input device 332. Specifically, the input device 332 may include but not limited to one or any of the combination of a physical keyboard, function keys (such as volume control keys, switch keys, etc.), a trackball, a mouse, and a joystick.

The display unit 340 may be configured to display information inputted by the user, information provided for the user, or various types of graphical user interfaces of the electronic device 300. The graphical user interfaces may include a graph, a text, an icon, a video, and any combination of them. The display unit 340 may include a display panel 341, optionally, which may be a liquid crystal display (LCD) or an Organic Light-Emitting Diode (OLED) display. Furthermore, the touch sensitive surface 331 may cover the display panel 341. When the touch sensitive surface 331 detects a touch operation on or near the touch sensitive surface 331 and transmits a corresponding signal to the processor 380 to determine a type of the touch event, the processor 380 controls the display panel 341 to provide appropriate visual output according to the type of the touch event. Although the touch sensitive surface 331 and the display panel 341 in FIG. 3 are two separate components for implementing input and output functions, the touch sensitive surface 331 and the display panel 341 may be integrated into one component for implementing the input and output functions in some embodiments.

The electronic device 300 may further include at least one sensor 350, such as a light sensor, a motion sensor, and other sensors. Specifically, the light sensor can include an ambient light sensor and a proximity sensor. The ambient light sensor can adjust the brightness of the display panel 341 according to bright or dark as to the ambient light. The proximity sensor can turn off the display panel 341 and/or the backlight when the electronic device 300 is moved close to ears. As one type of the motion sensor, a gravity sensor (G-sensor) can detect acceleration speed on all directions (generally up to three axis), can detect magnitude and direction of the gravity when it stays still, and can identify a gesture in a cell phone application (such as a screen switch between landscape style and portrait style, relevant games, and magnetometer calibration) and recognize vibration patterns to identify relevant functions (such as pedometer, and knock), and so on. Additionally, a gyroscope, a barometer, a hygrometer, a thermometer, an infrared sensor, and any other sensor can be deployed in the electronic device 300, and the details for these are not repeated herein.

The audio circuit 360, a speaker 361, and a microphone 362 provide an audio interface between the user and the electronic device 300. The audio circuit 360 converts received audio data to an electrical signal and transmits the electrical signal to the speaker 361. The speaker 361 converts the electrical signal to sound signals and outputs the sound signals. In addition, the microphone 362 converts collected sound signal to an electrical signal. The audio circuit 360 converts the electrical signal to audio data and transmits the audio data to the processor 380 for further processing. After the processing, the audio data may be transmitted to another terminal via the RF circuit 310, or transmitted to the storage 320 for further processing. The audio circuit 360 may further include an earphone jack for providing communication between an external earphone and the electronic device 300.

The electronic device 300 can be configured to, by the transmission module 370 (such as a WIFI module), send and receive emails, browse a webpage, and access to streaming media, and so on. It provides the user with wireless broadband internet access. It should be understood that although the transmission module 370 is illustrated in FIG. 3, this module is not an essential component for the electronic device 300 and can be omitted according to needs without departing from the scope of the present invention.

The processor 380 functions as a control center of the electronic device 300 and is configured to connect each component of the cell phone using various interfaces and circuits, and is configured to execute the various functions of the electronic device 300 and to perform data processing by running or executing the software programs and/or modules stored in the storage 320 and calling the data stored in the storage 320, thereby monitoring the overall cell phone. Optionally, the processor 380 may include one or more processing cores. Optionally, the processor 380 can include one or more processing cores. In some embodiments, an application processor and a modulation/demodulation processor can be integrated to form the processor 180. The application processor is primarily configured to process an operating system, user interfaces, application programs, and so on. The modulation/demodulation processor is primarily configured to process wireless communication. It should be understood that the modulation/demodulation processor can be independent from the processor 380.

The electronic device 300 further includes the power supply 390 (such as a battery) configured to provide power for the various components of the electronic device 300. In some embodiments, the power supply can be logically coupled to the processor 380 via a power management system that controls charging, discharging, power consumption, and so on. The power supply 390 may further include one or more direct current (DC)/or alternating current (AC) power sources, recharging system, power failure detection circuit, power converter or inverter, power supply status indicator, and the like. Although not being shown, the electronic device 300 may include a camera (such as a front camera and a rear camera), a BLUETOOTH module, and so on. They are not repeated herein.

Further, an embodiment of the present invention provides an interactive reminding device applied to the afore-mentioned electronic device 300.

FIG. 4 is a structural schematic diagram illustrating an interactive reminding device provided in an embodiment of the present invention. The interactive reminding device 400 includes an electrode sheet 401, and a control module 402, a feedback receiving unit 403 and a voltage adjusting configuration unit 404 that are implemented in the processor 380 of the electronic device 300. The control module 402 may realize an interactive reminding function by use of the processor 380.

The electrode sheet 401 is configured to contact with a user.

In the present embodiment, the electrode sheet 401 of the device may directly contact with the skin of a use such that the user is easier to perceive the action of the electrode sheet. The electrode sheet 401 may be an electrode sheet with electricity conducted.

The control module 402 is configured to apply, in response to a reminder event, a voltage to the electrode sheet 401 for the electrode sheet 401 to transmit the voltage to a user for reminding the user, and in response to receiving a feedback of the reminder, stop applying the voltage to the electrode sheet.

In the present embodiment, when the electronic device receives a reminder event such as a call reminder, a message reminder, an alarm reminder, the control module 402 may apply, in response to the reminder event, a voltage on the electrode sheet 401, and the electrode sheet 401 transmits the voltage to the user such that the user can perceive an electric current stimulus. The voltage applied by the control module 402 may be a direct-current voltage and the control module 402 may control the time length and the number in applying the voltage. Specifically, by a control circuit, the control module 402 outputs a voltage supplied by a power supply to the electrode sheet 401, and the electrode sheet 401 transmits the voltage to the user.

When the user gives a feedback in response to the reminder event, the device 400 may receive the feedback of the user. After notified, the control module 402 stop applying the voltage to the electrode sheet 401 in response to the feedback of the user. Specifically, the control module 402 may disable the control circuit to stop applying the voltage to the electrode sheet 401.

The feedback receiving unit 403 is configured to receive the feedback and notify the control module 402.

In the present embodiment, when the user perceives an electric current stimulus, the user may give a feedback such as rising the arm, clicking on the software and clicking on the screen and so on. The feedback receiving unit 403 receives the user's feedback and notifies the control module 402 to execute a program instruction to stop applying the voltage to the electrode sheet 401. The electrode sheet 401, the control module 402 and the feedback receiving unit 403 can make the electronic device realize the event reminding function for the user based on the electrode sheet.

Preferably, the applied voltage is treated as voltages applied to the electrode sheet for many times at interval until the user gives a feedback. This may enhance the reminding.

Preferably, the interactive reminding device further includes a voltage adjusting configuration unit 404 configured to make the control module 402 alter the voltage applied to the electrode sheet 401 based on an adjusted configuration of the applied voltage made by the user.

In the present embodiment, the user may adjust or configure the applied voltage by the voltage adjusting configuration unit 404, and the control module 402 may alter the applied voltage applied to the electrode sheet based on the adjusted configuration of the applied voltage made by the user. The voltage adjusting configuration unit 404 may display information regarding the strength of the applied voltage for the user to make an adjustment. Because sensitivity of electric stimulus is different for different persons, user experience may be improved if the strength of the voltage can be altered based on users' own perception. The user may also alter a total amount of time the voltage is applied.

Preferably, the applied voltage can be a pulse voltage. Common pulse waveforms include rectangular waves, sawtooth waves, spikes, trapezoidal waves, step waves, etc. Utilizing the electrode sheet to apply the pulse voltage to the user may form an electric stimulus with regular changes of voltage intensity, and alternating voltage intensity achieve the purpose of reminding the user.

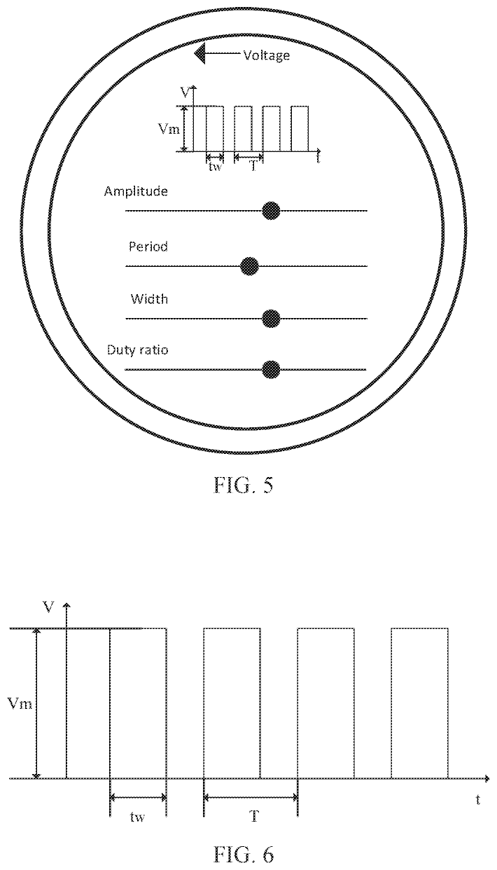

FIG. 5 is a schematic diagram illustrating an operational interface for a user to achieve voltage setting. The user may alter at least one of pulse amplitude, pulse period, pulse width and duty ratio of the pulse voltage.

In the present embodiment, the user may adjust or configure the pulse voltage using an interactive interface. When the user alters an option in the voltage setting, the voltage waveform may be changed accordingly.

FIG. 6 is a schematic diagram illustrating a waveform of a pulse voltage provided in an embodiment of the present invention. The pulse waveform may be a rectangular waveform, where Vm is the pulse amplitude, T is the pulse period, tw is the pulse width and a ratio of tw to T is the duty ratio. An adjustment on the pulse amplitude may alter the strength of electric stimulus received by the user. Adjustments on the pulse period, pulse width and duty ratio may alter the frequency of electric stimulus, the time length without the stimulus and the ratio of the time length without the stimulus to the period, respectively.

In the present embodiment, users may make the adjustment or configuration based on their needs, thereby improving the user experience. For example, the user may increase the pulse amplitude to strengthen the electric stimulus in a noisy environment, so as to prevent the user from ignoring a reminder. Alternatively, when the user needs to extend the time length without stimulus, the user may increase the pulse width.

Preferably, the voltage adjusting configuration unit 404 may preset the voltage applied to the electrode sheet based on importance of the reminder event. In the present embodiment, for more important events such as a phone call notification, the voltage applied to the electrode sheet may be preset as the highest level as to the voltage intensity provided by the system, for example. For less important events such as a short message notification or others, the voltage applied to the electrode sheet may be preset as a low level as to the voltage intensity.

Preferably, the user may configure the importance of the events so as to determine the importance of the reminder event, and then this information is delivered to the control module 402 along with the reminder event. In this way, determining the voltage applied to the electrode sheet based on the setting of importance of the reminder event may improve the user experience.

As can be seen from above description, in the interactive reminding device 400 provided in the present embodiment, in a situation that the electrode sheet 401 contacts with the user, when there is a reminder event, the control module 402 applies a voltage to the electrode sheet 401 in response to the reminder event, and the electrode sheet 401 transmits the voltage to the user. When the user gives a feedback, the feedback receiving unit 403 receives the feedback and notifies the control module 402. The control module 402 stops applying the voltage to the electrode sheet in response to the feedback of the user. Hence, when there is a reminder event, an electric stimulus can be given to the user by applying the voltage to the electrode sheet, thereby achieving the purpose of reminding the user. This approach is simple, safe, new and is not easy to be ignored by the user. Also, the user may adjust or configure the voltage intensity applied to the electrode sheet by the voltage adjusting configuration unit 404. The control module 402 alters the applied voltage on the electrode sheet based on the adjusted configuration. Hence, the user can set the electric intensity by itself, thereby improving the user experience.

Additionally, an embodiment of the present invention provides an interactive reminding method applied to the afore-mentioned device 400.

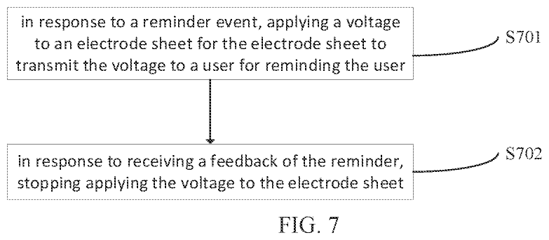

FIG. 7 is a flowchart of an interactive reminding method provided in an embodiment of the present invention. The interactive reminding method includes the following steps.

Step S701: in response to a reminder event, applying a voltage to an electrode sheet for the electrode sheet to transmit the voltage to a user for reminding the user.

In the present embodiment, when the electronic device receives a reminder event such as a call reminder, a message reminder, an alarm reminder, the electronic device may apply, in response to the reminder event, a voltage on the electrode sheet, and the electrode sheet transmits the voltage to the user such that the user can perceive an electric current stimulus. The applied voltage may be a direct-current voltage and the time length and the number in applying the voltage may be controllable. Specifically, by a control circuit, the electronic device outputs a voltage supplied by a power supply to the electrode sheet, and the electrode sheet transmits the voltage to the user.

Step S702: in response to receiving a feedback of the reminder, stopping applying the voltage to the electrode sheet.

In the present embodiment, when the user perceives an electric current stimulus, the user may give a feedback such as rising the arm, clicking on the software and clicking on the screen and so on. The electronic device may receive the user's feedback and stop applying the voltage to the electrode sheet in response to the user feedback. Specifically, the electronic device may disable the control circuit to stop applying the voltage to the electrode sheet. The afore-described steps can make the electronic device realize an event reminding function for the user based on the electrode sheet.

Preferably, the applied voltage is treated as voltages applied to the electrode sheet for many times at interval until the user gives a feedback. This may enhance the reminding.

Preferably, the interactive reminding method further includes altering the voltage applied to the electrode sheet based on an adjusted configuration of the applied voltage made by the user.

In the present embodiment, the user may adjust or configure the applied voltage by the voltage adjusting configuration unit 404 of the electronic device so as to alter the voltage applied to the electrode sheet. The voltage adjusting configuration unit 404 may display information regarding the strength of the applied voltage for the user to make an adjustment. Because sensitivity of electric stimulus is different for different persons, user experience may be improved if the strength of the voltage can be altered based on users' own perception. The user may also alter a total amount of time the voltage is applied.

Preferably, the applied voltage can be a pulse voltage. Common pulse waveforms include rectangular waves, sawtooth waves, spikes, trapezoidal waves, step waves, etc. Utilizing the electrode sheet to apply the pulse voltage to the user may form an electric stimulus with regular changes of voltage intensity, and alternating voltage intensity achieve the purpose of reminding the user.

As shown in FIG. 5, the user may alter at least one of pulse amplitude, pulse period, pulse width and duty ratio of the pulse voltage.

In the present embodiment, the user may adjust or configure the pulse voltage using an interactive interface. When the user alters an option in the voltage setting, the voltage waveform may be changed accordingly.

As shown in FIG. 6, the pulse waveform may be a rectangular waveform, where Vm is the pulse amplitude, T is the pulse period, tw is the pulse width and a ratio of tw to T is the duty ratio. An adjustment on the pulse amplitude may alter the strength of electric stimulus received by the user. Adjustments on the pulse period, pulse width and duty ratio may alter the frequency of electric stimulus, the time length without the stimulus and the ratio of the time length without the stimulus to the period, respectively.

In the present embodiment, users may make the adjustment or configuration based on their needs, thereby improving the user experience. For example, the user may increase the pulse amplitude to strengthen the electric stimulus in a noisy environment, so as to prevent the user from ignoring a reminder. Alternatively, when the user needs to extend the time length without stimulus, the user may increase the pulse width.

Preferably, the voltage adjusting configuration unit 404 may preset the voltage applied to the electrode sheet based on importance of the reminder event. In the present embodiment, for more important events such as a phone call notification, the voltage applied to the electrode sheet may be preset as the highest level as to the voltage intensity provided by the system, for example. For less important events such as a short message notification or others, the voltage applied to the electrode sheet may be preset as a low level as to the voltage intensity.

Preferably, the user may configure the importance of the events so as to determine the importance of the reminder event, and then this information is delivered to the control module 402 along with the reminder event. In this way, determining the voltage applied to the electrode sheet based on the setting of importance of the reminder event may improve the user experience.

As can be seen from above description, in the interactive reminding method provided in the present embodiment, in a situation that the electrode sheet of the electronic device contacts with the user, when there is a reminder event, the electronic device applies a voltage to the electrode sheet in response to the reminder event, and the electrode sheet transmits the voltage to the user. When the user gives a feedback, the electronic device stops applying the voltage to the electrode sheet in response to the feedback make by the user for the voltage. Hence, when there is a reminder event, an electric stimulus can be given to the user by applying the voltage to the electrode sheet, thereby achieving the purpose of reminding the user. This approach is simple, safe, new and is not easy to be ignored by the user. Also, the user may adjust or configure the voltage intensity applied to the electrode sheet. Hence, the user can set the electric intensity by itself, thereby improving the user experience.

A person of ordinary skill in the art may understand that all or some of the steps in various methods of the foregoing embodiments may be implemented by program instructions, or may be implemented by a program instructing relevant hardware. The program instructions may be stored in a computer readable storage medium, and be loaded and executed by a processor. For this, an embodiment of the present embodiment provides a storage medium, which stores a plurality of instructions that can be loaded by the processor to execute the steps of any of the interactive reminding methods provided in the embodiments of the present application.

The storage medium may include a read only memory (ROM), a random access memory (RAM), a magnetic disk or an optic disc.

Since the program instructions stored in the storage medium can execute the steps of any of the interactive reminding methods provided in the embodiments of the present application, it can realize the beneficial effects achieved by any of the interactive reminding methods provided in the embodiments of the present application, which are referred to above embodiments and are not repeated herein.

Implementation of above operations may refer to above embodiments, and is not repeated herein.

While the preferred embodiments of the present application have been illustrated and described in detail, various modifications and alterations can be made by persons skilled in this art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

What is claimed is:

1. An interactive reminding method, applied to an electronic device, the method comprising:
in response to a reminder event, applying a voltage to an electrode sheet for the electrode sheet to transmit the voltage to a user for reminding the user; and
in response to receiving a feedback of the reminder, stopping applying the voltage to the electrode sheet.

2. The interactive reminding method according to claim 1, further comprising altering the voltage applied to the electrode sheet based on an adjusted configuration of the applied voltage made by the user.

3. The interactive reminding method according to claim 2, wherein the voltage on the electrode sheet is a pulse voltage; and
wherein the altering the voltage applied to the electrode sheet comprises altering at least one of pulse amplitude, pulse period, pulse width and duty ratio of the pulse voltage.

4. The interactive reminding method according to claim 1, further comprising presetting the voltage applied to the electrode sheet based on importance of the reminder event.

5. The interactive reminding method according to claim 4, wherein the importance of the reminder event is determined based on an importance setting made by the user.

6. The interactive reminding method according to claim 1, wherein the applied voltage is treated as voltages applied to the electrode sheet for many times at interval.

7. The interactive reminding method according to claim 1, wherein the applied voltage is a direct-current voltage.

8. An interactive reminding device, comprising:
an electrode sheet, configured to contact with a user;
a control module, configured to apply, in response to a reminder event, a voltage to the electrode sheet for the electrode sheet to transmit the voltage to a user for reminding the user, and configured to stop applying the voltage to the electrode sheet in response to receiving a feedback of the reminder; and
a feedback receiving unit, configured to receive the feedback and notify the control module.

9. The interactive reminding device according to claim 8, further comprising a voltage adjusting configuration unit, configured to make the control module alter the voltage applied to the electrode sheet based on an adjusted configuration of the applied voltage made by the user.

10. The interactive reminding device according to claim 9, wherein the voltage on the electrode sheet is a pulse voltage; and
wherein the altering the voltage applied to the electrode sheet comprises altering at least one of pulse amplitude, pulse period, pulse width and duty ratio of the pulse voltage.

11. The interactive reminding device according to claim 9, wherein the voltage adjusting configuration unit preset the voltage applied to the electrode sheet based on importance of the reminder event.

12. The interactive reminding device according to claim 11, wherein the importance of the reminder event is determined based on an importance setting made by the user.

13. The interactive reminding device according to claim 8, wherein the applied voltage is treated as voltages applied to the electrode sheet for many times at interval.

14. A computer readable storage medium, storing a plurality of program instructions applicable to be loaded by a processor to execute the interactive reminding method of claim 1.

15. An electronic device, comprising a processor and a storage that are electrically connected to each other, the storage configured to store program instructions and data, the processor configured to execute the interactive reminding method of claim 1.

16. The electronic device according to claim 15, wherein the processor is configured to execute:
altering the voltage applied to the electrode sheet based on an adjusted configuration of the applied voltage made by the user.

17. The electronic device according to claim 16, wherein the voltage on the electrode sheet is a pulse voltage; and
wherein the altering the voltage applied to the electrode sheet comprises altering at least one of pulse amplitude, pulse period, pulse width and duty ratio of the pulse voltage.

18. The electronic device according to claim 15, wherein the interactive reminding method further comprising presetting the voltage applied to the electrode sheet based on importance of the reminder event.

19. The electronic device according to claim 18, wherein the importance of the reminder event is determined based on an importance setting made by the user.

20. The electronic device according to claim 15, wherein the applied voltage is treated as voltages applied to the electrode sheet for many times at interval.
